(19) United States
(12) Patent Application Publication
(10) Pub. No.: US 2026/0003934 A1
(43) Pub. Date: Jan. 1, 2026

(54) ARITHMETIC PROCESSING DEVICE AND ARITHMETIC PROCESSING METHOD

(71) Applicant: Fujitsu Limited, Kawasaki-shi (JP)

(72) Inventor: Hiroki Tokura, Yokohama (JP)

(73) Assignee: Fujitsu Limited, Kawasaki-shi (JP)

(21) Appl. No.: 19/318,671

(22) Filed: Sep. 4, 2025

Related U.S. Application Data
(63) Continuation of application No. PCT/JP2023/046850, filed on Dec. 27, 2023.

(30) Foreign Application Priority Data
Mar. 8, 2023 (JP) 2023-035942

(51) Int. Cl. G06F 17/16

(52) U.S. Cl. CPC G06F 17/16

(57) ABSTRACT

An arithmetic processing device includes processing circuitry. The processing circuitry is configured to asynchronously calculate, for a plurality of units of calculation for performing respective different calculations generated by dividing calculation of a standard eigenvalue problem for a predetermined symmetric matrix, a first task and a second task out of a plurality of tasks in which the respective units of calculation are executed when a dependency in which calculation of one of the first task and the second task is performed based on a result of calculation of the other is not present between the first task and the second task and sequentially calculate the first task and the second task when the dependency is present between the first task and the second task. The processing circuitry is configured to output a result of the calculation of the standard eigenvalue problem for the predetermined symmetric matrix calculated by the calculating.

### CROSS-REFERENCE TO RELATED APPLICATION

This application is a continuation application of International Application No. PCT/JP2023/046850, filed on Dec. 27, 2023 which claims the benefit of priority of the prior Japanese Patent Application No. 2023-035942, filed on Mar. 8, 2023, the entire contents of which are incorporated herein by reference.

### FIELD

The embodiments discussed herein are related to an arithmetic processing device and an arithmetic processing method.

### BACKGROUND

A standard eigenvalue problem for a matrix is the problem of finding all eigenvalues (λ) and eigenvectors (υ) expressed by Aυ=λυ for a specific square matrix. When the order of the specific square matrix is n×n, there are typically n pairs of eigenvalues (λ) and eigenvectors (υ), and they can be found by solving the standard eigenvalue problem. The standard eigenvalue problem is widely used in scientific and technological fields. In particular, the standard eigenvalue problem for a symmetric matrix is used in designing new drugs, analyzing big data, or the like and is an important topic in modern society.

To solve the standard eigenvalue problem for a symmetric matrix by a computer, the calculation is typically carried out by transforming the matrix as follows. First, the computer performs tridiagonalization on the symmetric matrix. Next, the computer calculates eigenvalues and eigenvectors for the tridiagonal matrix. Finally, the computer performs inverse transformation on the eigenvectors of the tridiagonal matrix and calculates eigenvalues and eigenvectors of the original symmetric matrix.

The tridiagonal matrix is a matrix in which only the diagonal elements and the elements adjacent above and below to the diagonal elements are nonzero. In tridiagonalization, a symmetric matrix is transformed into a tridiagonal matrix by similarity transformation of the matrix. The Householder matrix using Householder transformation is known as the matrix used for this transformation.

In tridiagonalization, one of the following three methods is typically used. The first method, which is called a QR method, is a method for solving the standard eigenvalue problem using similarity transformation with an orthogonal matrix. The QR method has the characteristic of facilitating stably finding the eigenvalues and eigenvectors. The second method is called a multiple relatively robust representations (MRRR) method. The MRRR method has the characteristic of facilitating solving the standard eigenvalue problem with high accuracy. The third method is called a divide-and-conquer method. The divide-and-conquer method is a method for calculating the eigenvalues and eigenvectors by dividing a matrix into smaller matrices. The divide-and-conquer method has the characteristic of facilitating calculation with high parallelism. Recent computers have significantly high parallelism due to their large scale. Therefore, the divide-and-conquer method is often used to solve the standard eigenvalue problem with high parallelism.

To solve various mathematical problems, including the standard eigenvalue problem, matrix operations and the like are frequently performed. For this reason, Basic Linear Algebra Subprograms (BLAS), which is a collection of basic operations of linear algebra, Linear Algebra Package (LAPACK), which is a collection of standard eigenvalue problem calculation functions and singular value problem calculation functions, and the like are released as open source. Typically, the standard eigenvalue problem for a symmetric matrix can be calculated by combining BLAS and LAPACK. BLAS and LAPACK are frequently used, so various tuned libraries are provided from various vendors.

The recent trend in processors is to improve the calculation performance by incorporating more cores. For example, the number of cores in processors developed by Fujitsu for the K computer and the Supercomputer Fugaku increases from 8 to 48. The number of cores in GPUs for flagships developed by NVIDIA Corporation increases in order of 5120 (V100), 6912 (A100), and 16896 (H100). When using such a processor, it is preferable to use an algorithm with high parallelism that uses up all the cores to enhance the calculation performance.

To solve the standard eigenvalue problem for a symmetric matrix of double precision using the divide-and-conquer method by LAPACK, a special function for the standard eigenvalue problem for a symmetric matrix of double precision (function called double to symmetric eigenvalue using divide-and-conquer algorithm (DSYEVD)) is used. In DSYEVD, processing is mainly composed of functions called DSYTRD, DSTEDC, and DORMTR. Double to symmetric tridiagonal form reduce (DSYTRD) is a function to perform tridiagonalization on a symmetric matrix. Double to symmetric tridiagonal eigenvalue using divide-and-conquer algorithm (DSTEDC) is a function to solve the standard eigenvalue problem for a tridiagonal matrix using the divide-and-conquer method. Double overwrite real M-by-N matrix with trans (DORMTR) is a function to perform inverse transformation on eigenvectors of a tridiagonal matrix by matrix multiplication.

The following describes the characteristics of each function. DSYTRD tends to be less likely to cause cache hits, and the parallelism decreases as the calculation proceeds. DSTEDC enables calculation with high parallelism and high calculation efficiency. DORMTR enables calculation with high calculation efficiency. Therefore, DSYTRD typically occupies a large part of the total calculation time in solving the standard eigenvalue problem for a symmetric matrix. Considering the characteristics of each function, it is expected that solving the performance problem in DSYTRD can improve the overall performance.

Various techniques of parallel processing have been developed, including a technique of dividing a given calculation model to construct a plurality of sub-calculations that are not interdependent and causing a plurality of processors to process the respective sub-calculations in parallel. The related technologies are described, for example, in Japanese National Publication of International Patent Application No. 2022-500755.

In the calculation of the standard eigenvalue problem for a symmetric matrix, however, the calculation for tridiagonalization by DSYTRD creates a bottleneck because DSYTRD has the characteristics that it tends to be less likely to cause cache hits and that the parallelism decreases as the calculation proceeds. Therefore, if the tendency to be less likely to cause cache hits fails to be improved, it is difficult to improve the calculation efficiency as long as the standard eigenvalue problem for a symmetric matrix of double precision is solved by the divide-and-conquer method.

For example, the following describes the process of actual calculation by DSYTRD for a symmetric matrix of 16×16. To perform the first similarity transformation, the elements in the first to the 15-th rows of the 0-th column are accessed, and a Householder matrix is calculated. The Householder matrix can be expressed using vectors, so it is actually held in the form of vectors. Subsequently, similarity transformation is performed using the Householder matrix. The similarity transformation is performed by matrix-vector multiplication and has low cache efficiency, thereby causing a lot of waits in the calculation. In the first similarity transformation, substantially 225 (=15×15) elements are updated. In the second similarity transformation, calculation is performed in the same manner as in the 0-th column. In the second similarity transformation, substantially 196 (=14×14) elements are updated. When such calculations are repeated, the number of elements updated by the similarity transformation decreases significantly, and sufficient parallelism fails to be provided. Therefore, if a plurality of threads are available, calculation is performed by some of the threads, making it difficult to fully bring out the calculation performance of the processor.

Being less likely to cause cache hits, which is one of the characteristics of DSYTRD, can be prevented to some extent by changing the calculation algorithm. To achieve this, it is conceivable to use an algorithm called dsytrd_2stage included in LAPACK, for example. When dsytrd_2stage is used, however, the amount of calculation is approximately twice in the part corresponding to DORMIR in the eigenvector calculation. For this reason, it is preferable to use different algorithms corresponding to the calculation stages. If dsytrd_2stage is used, however, it is difficult to prevent reduced parallelism in tridiagonalization.

### SUMMARY

According to an aspect of an embodiment, an arithmetic processing device includes processing circuitry. The processing circuitry is configured to asynchronously calculate, for a plurality of units of calculation for performing respective different calculations generated by dividing calculation of a standard eigenvalue problem for a predetermined symmetric matrix, a first task and a second task out of a plurality of tasks in which the respective units of calculation are executed when a dependency in which calculation of one of the first task and the second task is performed based on a result of calculation of the other is not present between the first task and the second task and sequentially calculate the first task and the second task when the dependency is present between the first task and the second task. The processing circuitry is configured to output a result of the calculation of the standard eigenvalue problem for the predetermined symmetric matrix calculated by the calculating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a computer according to an embodiment;

FIG. 2 is a diagram of an example of thread parallel and task parallel;

FIG. 3 is a diagram of the process of calculation of a standard eigenvalue problem;

FIG. 4 is a diagram of the process of calculation of tridiagonalization by DSYTRD;

FIG. 5 is a diagram of an example of a dependency graph according to a first embodiment;

FIG. 6 is a flowchart of the process of calculation of the standard eigenvalue problem by a processor according to the embodiment;

FIG. 7 is a flowchart of an asynchronous execution availability determination process;

FIG. 8 is a flowchart of a dependency determination process;

FIG. 9 is a flowchart of an asynchronous execution determination process;

FIG. 10 is a diagram of an example of a timeline comparing a case where asynchronous execution of units of calculation is performed and a case where not performed in the calculation of the standard eigenvalue problem;

FIG. 11 is a diagram of a comparison of the calculation speed between the calculation of the standard eigenvalue problem by the processor according to the first embodiment and the calculation when asynchronous execution of the units of calculation is not performed;

FIG. 12 is a diagram of an example of the dependency graph according to a second embodiment;

FIG. 13 is a diagram of division of a matrix in DSTEDC;

FIG. 14 is a diagram of calculation of eigenvalues and eigenvectors of recursive matrices in DSTEDC;

FIG. 15 is a diagram of a comparison of the calculation speed between the calculation of the standard eigenvalue problem by the processor according to a second embodiment and the calculation when asynchronous execution of the units of calculation is not performed;

FIG. 16 is a diagram of an example of the dependency graph according to a third embodiment; and

FIG. 17 is a diagram of the outline of calculation by DORMIR according to the third embodiment.

### DESCRIPTION OF EMBODIMENTS

Preferred embodiments of the present invention will be explained with reference to accompanying drawings. The embodiments below do not limit the arithmetic processing device and the arithmetic processing method according to the present disclosure.

### (a) First Embodiment

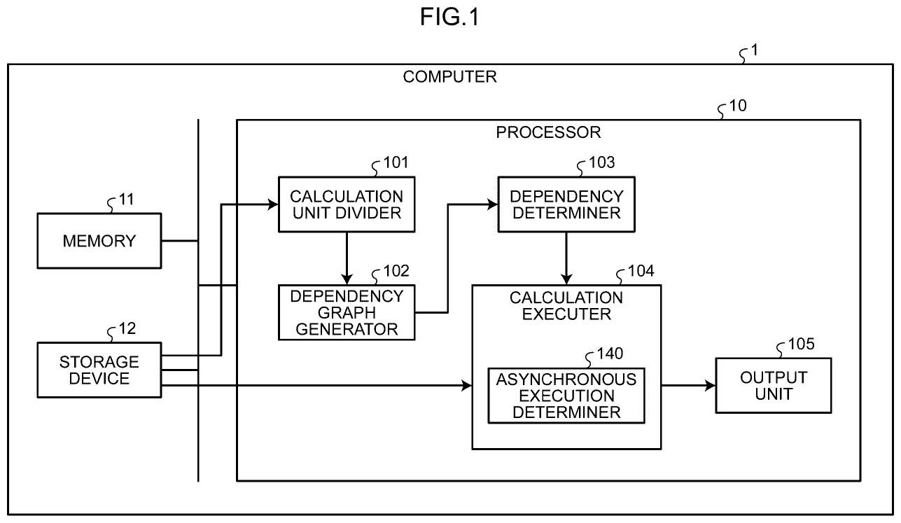

FIG. 1 is a block diagram of a computer according to an embodiment. The present embodiment describes a case where a computer 1 solves a standard eigenvalue problem using LAPACK or BLAS serving as a library of basic operations of linear algebra. The algorithm used by the computer 1, however, is not particularly limited as long as it is an algorithm to calculate the standard eigenvalue problem.

The computer 1 includes a processor 10, a memory 11, and a storage device 12. The processor 10, the memory 11, and the storage device 12 are each connected to a bus and can transmit and receive data to and from each other.

The processor 10 includes a plurality of cores. Each core can execute one thread at a time. In other words, the processor 10 can execute a plurality of threads. The processor 10 can execute a plurality of threads in parallel. Execution of a plurality of threads in parallel is referred to as thread parallel.

A unit of calculation according to the present embodiment refers to a function of mathematical processing provided by LAPACK and BLAS and a unit of processing for the processor 10 to carry out the calculation, or mathematical processing defined by a user or a unit of processing for the processor 10 to carry out the calculation. The unit of calculation can be optionally defined as long as it is a calculation or processing that yields some results. If the unit of calculation is made small, however, the result obtained by the unit of calculation alone may be a meaningless result, such as a mere intermediate step in a larger calculation or processing including the unit of calculation. Such a unit of calculation is not preferably used because it complicates the processing. The unit of calculation according to the present embodiment is a calculation or processing that yields a mathematically meaningful result.

The unit of calculation according to the present embodiment may be those described below. One of the units of calculation is a function to perform matrix multiplication of double-precision real numbers, that is, dgemm in BLAS, for example. Another one of the units of calculation is a function to calculate eigenvalues and eigenvectors of a tridiagonal symmetric matrix of double-precision real numbers, that is, dstegr in LAPACK, for example.

Another one of the units of calculation is a function to duplicate a matrix of double precision, that is, dlacpy in LAPACK, for example. LAPACK and BLAS also have a function that assumes overwriting a matrix and a vector. Therefore, duplication of a matrix and a vector to carry out the calculation on the computer 1 is also defined as the unit of calculation according to the present embodiment.

Another one of the units of calculation is a function to temporarily save array elements to perform a calculation defined by the user. The arrays also include matrices. While the temporary saving of array elements is mathematically meaningless, it needs to be performed to carry out the processing from a programmatic point of view. Therefore, such a function is also regarded as the unit of calculation. Thus, the processing defined by the user to solve the problem can also be the unit of calculation according to the present embodiment.

By contrast, the following examples are not regarded as the unit of calculation according to the present embodiment. One is a function for error handling, that is, xerbla called from dgemm in BLAS, for example. Error handling is not mathematical processing or processing for carrying out the calculation on the computer 1, so xerbla is not regarded as the unit of calculation. For example, xerbla is regarded as processing included in the unit of calculation of dgemm serving as the unit of calculation. Another one is a multiply-accumulate operation inside dgemm in BLAS. The multiply-accumulate operation itself, which constitutes dgemm, has no mathematical final meaning. The multiply-accumulate operation inside dgemm is regarded as processing included in dgemm serving as the unit of calculation.

Another one is a function to obtain a constant in double-precision real numbers, that is, dlamch inside dsteqr in LAPACK, for example. Dlamch is a function to obtain a constant needed in the calculation of dsteqr and does not serve as the unit of calculation because it is not mathematical processing. Dlamch is regarded as processing included in dsteqr serving as the unit of calculation. Another one is dgemm inside dstedc in LAPACK, which is regarded as the unit of calculation. Dgemm called inside dstedc serving as the unit of calculation is regarded as processing included in dstedc.

Another one is processing of outputting the results of calculation of dsteqr implemented by the user to standard output. This processing is not regarded as the unit of calculation because it is not mathematical processing or processing needed to carry out the calculation on the computer 1. This processing is regarded as processing included in dsteqr serving as the unit of calculation.

The processor 10 regards each unit of calculation included in a computer program for solving the standard eigenvalue problem as one task. A task includes one or a plurality of threads. The processor 10 can execute a plurality of tasks in parallel. Asynchronous execution of a plurality of tasks is referred to as asynchronous execution of tasks. The unit of calculation processed in a task may also be referred to as asynchronous execution of the unit of calculation. In asynchronous execution of tasks, the processor 10 executes each task independently, instead of executing the tasks in order according to the description of the computer program.

To process the tasks asynchronously, the processor 10 according to the present embodiment uses a task parallel function of OpenMP (multiprocessing). Actually, however, the processor 10 preferably selects an appropriate algorithm for each architecture. For example, if the performance is easy to achieve by using the task parallel function of OpenMP due to high-speed synchronization by the hardware barrier function, the processor 10 preferably uses OpenMP. Alternatively, the processor 10 may use the stream function and the CUDA Graphs function.

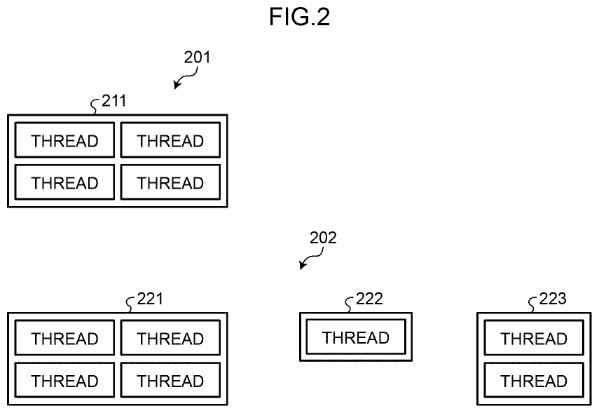

FIG. 2 is a diagram of an example of thread parallel and task parallel. For example, the processor 10 performs calculation as indicated by thread parallel 201. In other words, the processor 10 performs calculation in a plurality of threads for a task 211 for executing one unit of calculation.

The processor 10 also performs calculation as indicated by task parallel 202. In this case, the processor 10 executes a task 221, a task 222, and a task 223 in parallel, that is, asynchronously. When focusing on a certain unit of calculation in the task parallel 202, if a plurality of threads are allocated to the unit of calculation, the processor 10 is executing the processing of the unit of calculation in thread parallel. In other words, the processor 10 executes the processing of the tasks 221 and 223 in thread parallel. Specifically, in task parallel, the processor 10 calculates a plurality of units of calculation at the same timing in one or a plurality of threads. In task parallel, the processor 10 is only expected to process a plurality of units of calculation at the same timing and may actually process the units of calculation at different timings.

Referring back to FIG. 1, the explanation is continued. The processor 10 solves the standard eigenvalue problem using the thread parallel and the task parallel. The processor 10 calculates the standard eigenvalue problem for a symmetric matrix.

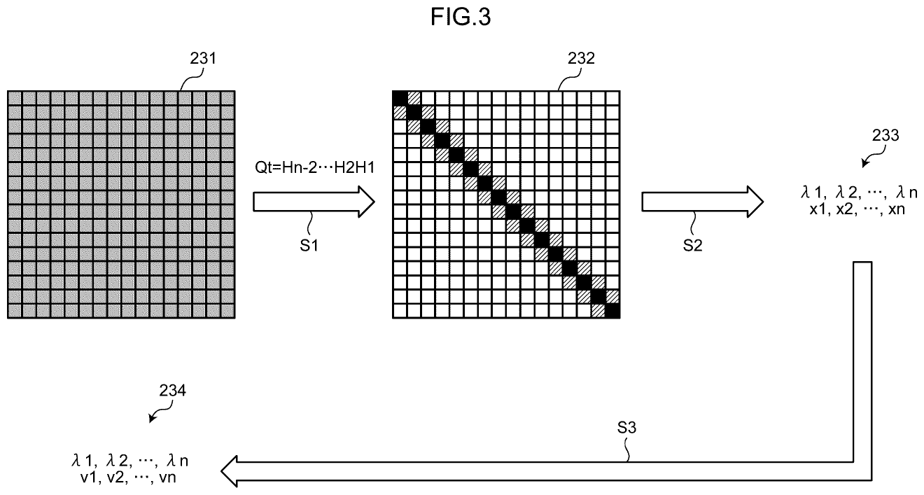

FIG. 3 is a diagram of the process of calculation of the standard eigenvalue problem. The following describes the outline of the process of calculation of the standard eigenvalue problem by the processor 10 according to the present embodiment with reference to FIG. 3. In the following description, a symmetric matrix 231 is an n×n matrix, for example.

The processor 10 performs tridiagonalization on the symmetric matrix 231 using DSYTRD to derive a tridiagonal matrix 232 (Step S1). In the tridiagonalization, the processor 10 accumulates a Householder matrix Hi used in the i-th similarity transformation into an orthogonal matrix Qt for the calculation of eigenvectors. After completing the tridiagonalization, the processor 10 obtains Qt=Hn−2 . . . H2H1.

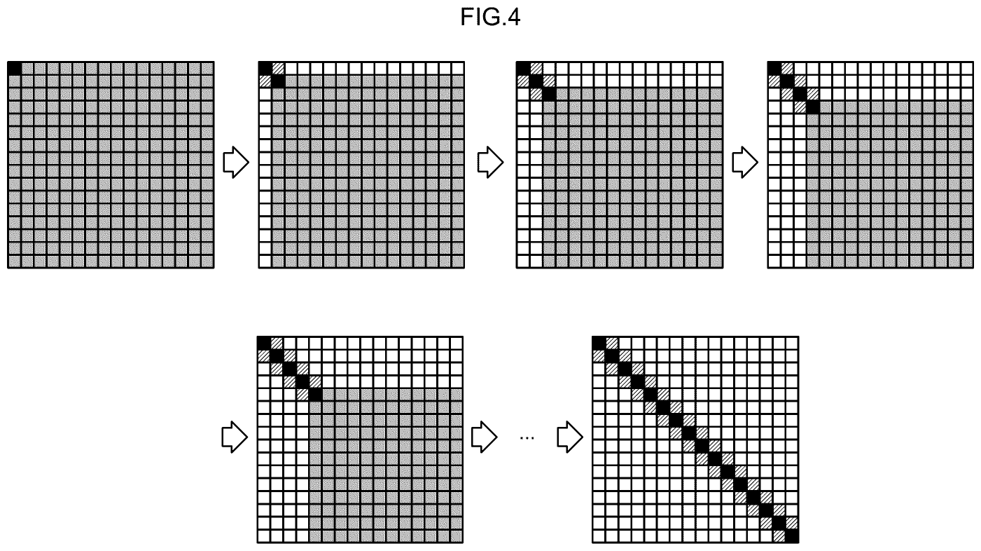

FIG. 4 is a diagram of the process of calculation of tridiagonalization by DSYTRD. By executing DSYTRD, the processor 10 transforms the symmetric matrix into a tridiagonal matrix column by column from the left column to the right column as illustrated in FIG. 4. At this time, the processor 10 can perform tridiagonalization on one column by one similarity transformation. In FIG. 4, determined diagonal elements are represented in black, determined sub-diagonal elements are represented by a hatched pattern, other determined elements are represented in white, and undetermined elements are represented in gray. In the n×n symmetric matrix, the tridiagonalization is completed by n−2 similarity transformations.

Referring back to FIG. 3, the explanation is continued. Subsequently, the processor 10 calculates eigenvalues (λ1, λ2, . . . , λn) and eigenvectors (x1, x2, . . . , xn) of the tridiagonal matrix 232 indicated as a solution 233 (Step S2).

Subsequently, the processor 10 performs inverse transformation on the eigenvectors (x1, x2, . . . , xn) to calculate eigenvectors (υ1, υ2, . . . , υn) of the symmetric matrix 231. Thus, the processor 10 obtains the eigenvalues (λ1, λ2, . . . , λn) and the eigenvectors (υ1, υ2, . . . , υn) of the symmetric matrix 231 indicated as a solution 234 (Step S3).

Referring back to FIG. 1, the explanation is continued. The memory 11 is a main storage device. The memory 11 is, for example, a dynamic random-access memory (DRAM). The memory 11 is used by the processor 10 as a storage area in arithmetic processing, for example.

The storage device 12 is an auxiliary storage device and is, for example, a hard disk or a solid-state drive (SSD). The storage device 12 stores therein various computer programs for the processor 10 to perform arithmetic processing. The storage device 12 stores therein data for the processor 10 to perform arithmetic processing. For example, the storage device 12 stores therein a symmetric matrix for which eigenmatrices and eigenvalues are to be obtained by the standard eigenvalue problem.

Next, the calculation of the standard eigenvalue problem by the processor 10 according to the present embodiment is described in detail. As illustrated in FIG. 1, the processor 10 includes a calculation unit divider 101, a dependency graph generator 102, a dependency determiner 103, a calculation executer 104, and an output unit 105.

The calculation unit divider 101 includes prespecified rules for generating the unit of calculation. The calculation unit divider 101 acquires a symmetric matrix for which the standard eigenvalue problem is to be calculated from the storage device 12. Then, the calculation unit divider 101 divides the entire calculation of the standard eigenvalue problem into units of calculation to generate the units of calculation according to the generation rules based on the characteristics of the symmetric matrix, such as the number of rows and columns. Subsequently, the calculation unit divider 101 outputs the information on the generated units of calculation to the dependency graph generator 102.

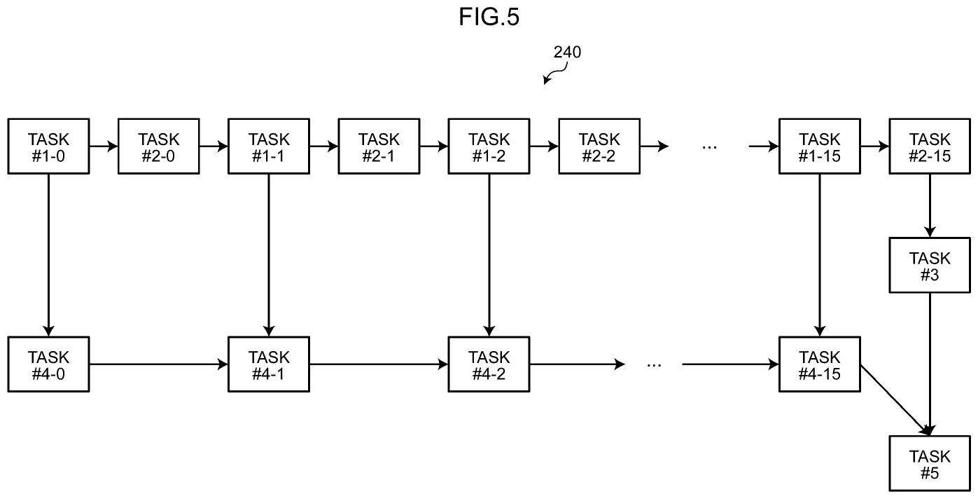

FIG. 5 is a diagram of an example of a dependency graph according to a first embodiment. FIG. 5 illustrates an example of the dependencies between tasks corresponding to the units of calculation in the calculation of the standard eigenvalue problem.

For example, the calculation unit divider 101 defines generation of the Householder matrix Hi in the calculation by DSYTRD in the calculation of the standard eigenvalue problem as one unit of calculation. i represents the i-th column of the symmetric matrix, and Hi represents the Householder matrix of the i-th column. Task #1-i in FIG. 5 represents the unit of calculation for generating the Householder matrix Hi. Task #1-i corresponds to this unit of calculation and represents the processing of generating the Householder matrix Hi of the i-th column.

The calculation unit divider 101 defines similarity transformation in the calculation by DSYTRD in the calculation of the standard eigenvalue problem as one unit of calculation. Task #2-i in FIG. 5 corresponds to this unit of calculation and represents the processing of performing similarity transformation using the Householder matrix Hi of the i-th column.

The calculation unit divider 101 defines calculation of eigenvalues and eigenvectors of the tridiagonal matrix by DSTEDC in the calculation of the standard eigenvalue problem as one unit of calculation. Task #3 in FIG. 5 corresponds to this unit of calculation.

The calculation unit divider 101 defines transformation of the Householder matrix Hi into a determinant in the calculation by DORMTR in the calculation of the standard eigenvalue problem as one unit of calculation. Task #4-i in FIG. 5 corresponds to this unit of calculation and represents the transformation of the Householder matrix Hi of the i-th column into a determinant.

The calculation unit divider 101 defines matrix multiplication in the calculation by DORMTR in the calculation of the standard eigenvalue problem as one unit of calculation. Task #5 in FIG. 5 corresponds to this unit of calculation.

Referring back to FIG. 1, the explanation is continued. The dependency graph generator 102 receives input of the information on the unit of calculation of the calculation of the standard eigenvalue problem for the symmetric matrix from the calculation unit divider 101. Subsequently, when a task for executing a specific unit of calculation uses the results derived by a task for executing a second unit of calculation as input information, the dependency graph generator 102 generates information indicating the input-output relation of the results of calculation between the tasks. For example, the dependency graph generator 102 places an arrow from the second unit of calculation that outputs the results toward the specific unit of calculation.

For example, when the Householder matrix Hi of the i-th column is generated in DSYTRD, similarity transformation is performed using the Householder matrix Hi. The Householder matrix Hi of the i-th column generated in DSYTRD is transformed into a determinant by DORMTR. Therefore, the dependency graph generator 102 places arrows from task #1-i to tasks #2-i and #4-i as indicated by a dependency graph 240 in FIG. 5 to generate the information indicating the input-output relation.

The dependency graph generator 102 generates the information indicating the input-output relation for all the units of calculation. Thus, the dependency graph generator 102 generates the dependency graph 240 illustrated in FIG. 5, for example. Subsequently, the dependency graph generator 102 outputs the generated dependency graph to the dependency determiner 103. While a non-dependency graph is represented as a two-dimensional graph to simplify the explanation in the present embodiment, the dependency graph may be information in any other form as long as it is information from which the information on the input-output relation between the tasks can be acquired.

The dependency determiner 103 receives input of the dependency graph from the dependency graph generator 102. Subsequently, the dependency determiner 103 extracts a combination of tasks having no dependencies from the acquired dependency graph. When the results output by a first task are directly or indirectly used for calculation by a second task, or when the results output by the second task are directly or indirectly used for calculation by the first task, it can be said that a dependency is present between the first task and the second task. After extracting the combination of tasks having no dependencies, the dependency determiner 103 outputs information on each unit of calculation and information on the combination of tasks having no dependencies to the calculation executer 104. The extraction of tasks having no dependencies is described below in detail with reference to FIG. 5.

The dependency graph is a directed graph having a direction for each input-output relation. The following describes the extraction of different tasks A and B present in the dependency graph, for example. If there is a path from the task A to the task B or from the task B to the task A according to the direction of the input-output relation, the dependency determiner 103 determines that a dependency is present between the task A and the task B. By contrast, if there is no path from the task A to the task B or from the task B to the task A according to the direction of the input-output relation, the dependency determiner 103 determines that no dependency is present between the task A and the task B.

For example, there is no path connecting from task #2-0 to task #4-0 or from task #4-0 to task #2-0 according to the direction of the input-output relation between task #2-0 and task #4-0 in FIG. 5. Therefore, the dependency determiner 103 determines that no dependency is present between task #2-0 and task #4-0. Similarly, there is no path connecting between task #1-2 and task #4-1 according to the direction of the input-output relation, so the dependency determiner 103 determines that no dependency is present between task #1-2 and task #4-1.

By contrast, there is no path connecting from task #4-2 to task #2-0 according to the direction of the input-output relation between task #2-0 and task #4-2, but there is a path connecting from task #2-0 to task #4-2. Therefore, the dependency determiner 103 determines that a dependency is present between task #2-0 and task #4-2.

Referring back to FIG. 1, the explanation is continued. The calculation executer 104 includes an asynchronous execution determiner 140. The calculation executer 104 receives input of the information on each unit of calculation and the information on the combination of tasks having no dependencies from the dependency determiner 103. The calculation executor 104 acquires a symmetric matrix from the storage device 12.

Subsequently, the calculation executer 104 starts to execute the calculation of the standard eigenvalue problem outlined in FIG. 3 for the acquired symmetric matrix. In the calculation of the standard eigenvalue problem, the calculation executer 104 executes the calculation of the units of calculation asynchronously for the tasks having no dependencies. By contrast, the calculation executer 104 processes in order the tasks having dependencies and not to be subjected to asynchronous calculation by calling a function to perform calculation of the units of calculation of the respective tasks sequentially in a predetermined order.

More specifically, after a certain task is completed, the asynchronous execution determiner 140 of the calculation executer 104 extracts tasks having no dependencies from the tasks that can be executed next to the certain task. The asynchronous execution determiner 140 determines whether the calculation speed increases if a specific task and the extracted tasks are asynchronously executed. If it is determined that the calculation speed increases, the asynchronous execution determiner 140 determines to execute the specific task and the extracted tasks asynchronously. The calculation executer 104 executes the tasks according to the determination of the asynchronous execution determiner 140.

In FIG. 5, for example, no dependency is present between task #2-i and task #4-i after task #1-i is completed. Therefore, the asynchronous execution determiner 140 determines that task #2-i and task #4-i can be asynchronously executed. If the asynchronous execution determiner 140 determines to execute task #2-i and task #4-i asynchronously, the calculation executer 104 executes task #2-i and task #4-i asynchronously.

The calculation executer 104 can calculate the units of calculation that can be asynchronously calculated by using the task parallel function of OpenMP, for example. With the task parallel function, the calculation executor 104 can allocate tasked processing as threads and process them asynchronously. For example, task #2-i and task #4-i are relatively heavy processing, so they are preferably executed in thread parallel. Therefore, the calculation executer 104 processes task #2-i and task #4-i using #pragma omp taskloop. As a result, the thread allocated to task #2-i may be allocated to the processing of task #4-i after the calculation is completed, and vice versa. In other words, the calculation executor 104 may be able to execute task #2-i and task #4-i asynchronously. This configuration can be expected to improve the efficiency of the processor 10.

To execute tasks asynchronously, various controls are performed depending on the dependencies of the tasks. If the dependencies between the tasks are defined, the tasks can be automatically executed. For example, the calculation executer 104 can automatically execute the tasks with the stream function and the CUDA Graphs function in CUDA provided by NVIDIA Corporation. To use the stream function, the calculation executer 104 prepares queues called stream. The calculation executer 104 inputs the tasks having no dependencies to different queues, thereby asynchronously executing the tasks having no dependencies. In this case, the tasks input to the same queue are considered to have dependencies and are executed in order. To use the CUDA Graphs function, the calculation executer 104 defines the dependencies of the tasks and then executes the tasks. At this time, the tasks having no dependencies are likely to be asynchronously executed, and the tasks having dependencies are executed in an appropriate order.

If the calculation amount of the unit of calculation executed in each task is equal to or larger than a predetermined value, the calculation executer 104 executes the calculation of the unit of calculation included in the task in a plurality of threads. If the calculation amount of the unit of calculation executed in each task is smaller than the predetermined value, the calculation executer 104 executes the calculation of the unit of calculation included in the task in a single thread.

By completing the execution of all the tasks, the calculation executer 104 completes the calculation of eigenvalues and eigenvectors of the symmetric matrix. The calculation executer 104 notifies the output unit 105 of the calculated eigenvalues and eigenvectors of the symmetric matrix.

As described above, the calculation executer 104 according to the present embodiment executes calculation for a plurality of units of calculation including the units of calculation obtained by dividing the calculation of tridiagonalization of a symmetric matrix (DSYTRD) included in the calculation of the standard eigenvalue problem for a predetermined symmetric matrix based on whether a dependency is present between the first task and the second task.

The output unit 105 receives the notification of the eigenvalues and eigenvectors of the symmetric matrix from the calculation executer 104. The output unit 105 presents the calculation results to the user by displaying the received eigenvalues and eigenvectors of the symmetric matrix on a display device or the like.

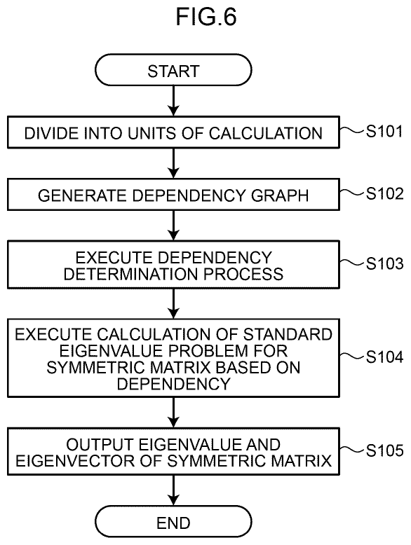

FIG. 6 is a flowchart of the process of calculation of the standard eigenvalue problem by the processor according to the embodiment. The following describes the procedure of the calculation of the standard eigenvalue problem by the processor 10 according to the present embodiment with reference to FIG. 6.

The calculation unit divider 101 divides the calculation of the standard eigenvalue problem for a symmetric matrix into units of calculation according to the predetermined rules for generating the units of calculation (Step S101).

The dependency graph generator 102 generates information on the input-output relation between the units of calculation generated by the calculation unit divider 101 to generate a dependency graph (Step S102).

The dependency determiner 103 executes a dependency determination process to determine the dependencies between tasks using the dependency graph generated by the dependency graph generator 102 (Step S103).

The calculation executer 104 executes calculation of the standard eigenvalue problem for the symmetric matrix based on the determination of whether to execute the tasks asynchronously by the asynchronous execution determiner 140 according to the dependencies between the tasks (Step S104).

The output unit 105 outputs the eigenvalues and eigenvectors of the symmetric matrix calculated by the calculation executer 104 and provides them to the user (Step S105).

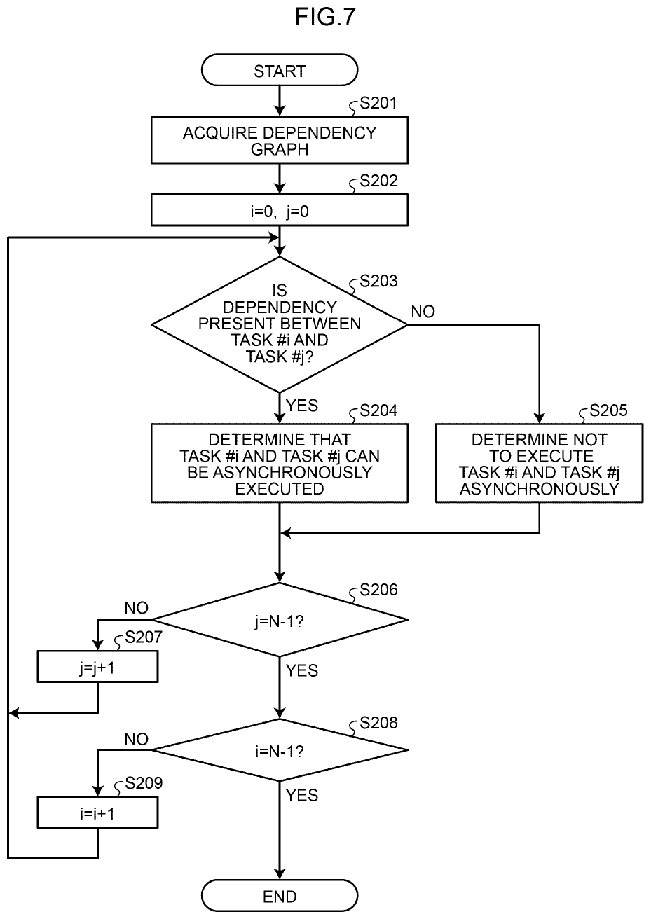

FIG. 7 is a flowchart of an asynchronous execution availability determination process. The processing indicated by the flowchart in FIG. 7 is an example of the processing performed at Steps S103 and S104 in FIG. 6. The flowchart in FIG. 7, however, illustrates each processing when Steps S103 and S104 are performed in parallel, for example. The following describes the procedure of the asynchronous execution availability determination process by the processor 10 according to the present embodiment with reference to FIG. 7. In the following description, the symmetric matrix is an n×n matrix, and the tasks are sequentially numbered.

The dependency determiner 103 acquires the dependency graph from the dependency graph generator 102 (Step S201).

Subsequently, the dependency determiner 103 sets i=0 and j=0 (Step S202).

Subsequently, the dependency determiner 103 determines whether a dependency is present between task #i and task #j (Step S203).

If a dependency is present between task #i and task #j (Yes at Step S203), the asynchronous execution determiner 140 determines that task #i and task #j can be asynchronously executed (Step S204).

By contrast, if no dependency is present between task #i and task #j (No at Step S203), the asynchronous execution determiner 140 determines not to execute task #i and task #j asynchronously (Step S205).

Subsequently, the dependency determiner 103 determines whether j=N−1 is satisfied (Step S206). If j≠N−1 is satisfied (No at Step S206), the dependency determiner 103 increments j by one (Step S207). Subsequently, the asynchronous execution availability determination process returns to Step S203.

By contrast, if j=N−1 is satisfied (Yes at Step S206), the dependency determiner 103 determines whether i=N−1 is satisfied (Step S208). If i≠N−1 is satisfied (No at Step S208), the dependency determiner 103 increments i by one (Step S209). Subsequently, the asynchronous execution availability determination process returns to Step S203.

By contrast, if i=N−1 is satisfied (Yes at Step S208), the dependency determiner 103 and the asynchronous execution determiner 140 terminate the asynchronous execution availability determination process.

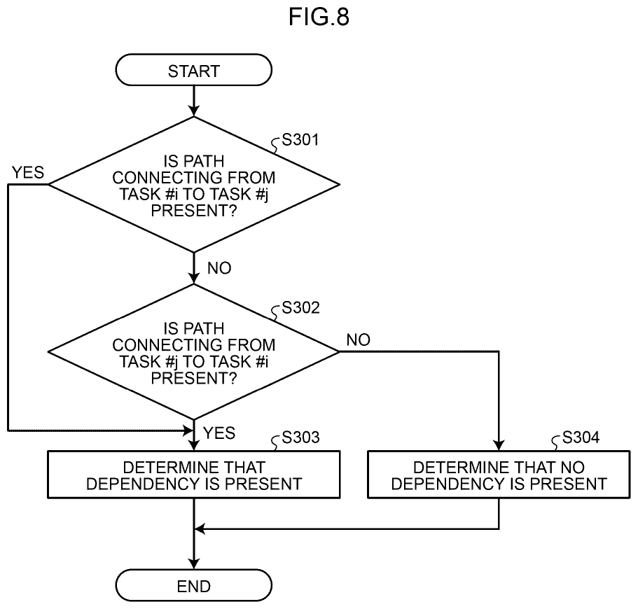

FIG. 8 is a flowchart of a dependency determination process. The processing indicated by the flowchart in FIG. 8 is an example of the processing performed at Step S203 in FIG. 7. The following describes the procedure of the dependency determination process by the processor 10 according to the present embodiment with reference to FIG. 8.

The dependency determiner 103 uses the dependency graph to determine whether a path connecting from task #i to task #j is present according to the direction of the input-output relation (Step S301).

If no path connecting from task #i to task #j is present (No at Step S301), the dependency determiner 103 determines whether a path connecting from task #j to task #i is present according to the direction of the input-output relation (Step S302).

If a path connecting from task #i to task #j is present (Yes at Step S301), the dependency determiner 103 determines that a dependency is present between task #i and task #j (Step S303). If a path connecting from task #j to task #i is present (Yes at Step S302), the dependency determiner 103 determines that a dependency is present between task #i and task #j (Step S303).

By contrast, if no path connecting from task #j to task #i is present (No at Step S302), the dependency determiner 103 determines that no dependency is present between task #i and task #j (Step S304).

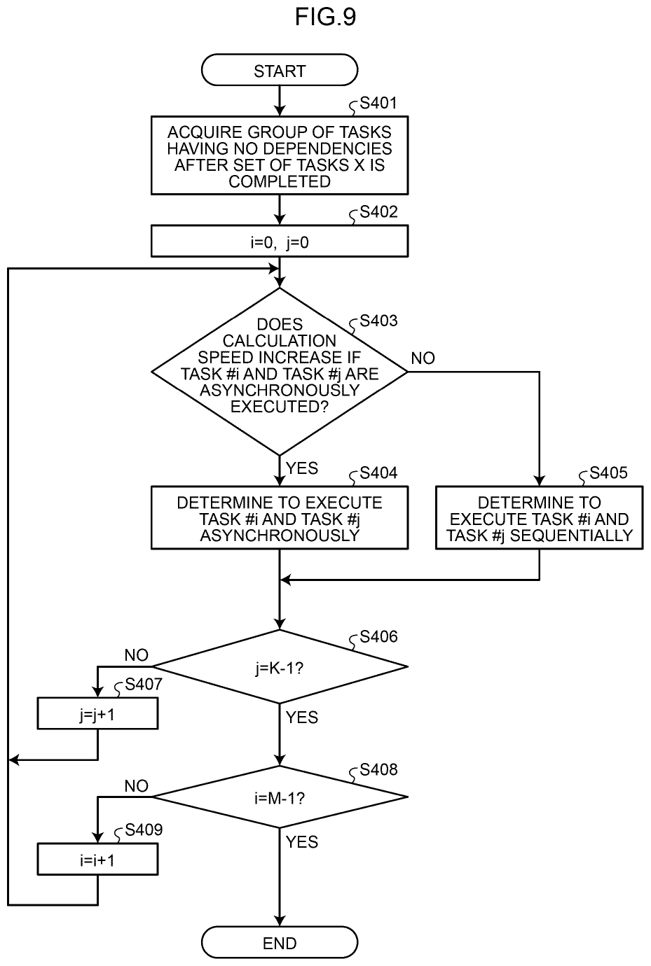

FIG. 9 is a flowchart of an asynchronous execution determination process. The processing indicated by the flowchart in FIG. 9 is an example of the processing performed at Step S104 in FIG. 6. The following describes the procedure of the asynchronous execution determination process by the processor 10 according to the present embodiment with reference to FIG. 9. In the following description, the symmetric matrix is an n×n matrix, and the tasks are sequentially numbered.

After a set of tasks X is completed, the asynchronous execution determiner 140 acquires a group of tasks having no dependencies with the tasks that can be executed next (Step S401). M is the number of tasks that can be executed next, and K is the number of tasks included in the group of tasks having no dependencies with the tasks that can be executed next.

Subsequently, the asynchronous execution determiner 140 sets task #i serving as the task that can be executed next to i=0. The asynchronous execution determiner 140 sets task #j included in the group of tasks having no dependencies with task #i to j=0 (Step S402).

Subsequently, the asynchronous execution determiner 140 determines whether the calculation speed increases if task #i and task #j are asynchronously executed (Step S403).

If the calculation speed increases (Yes at Step S403), the asynchronous execution determiner 140 determines to execute task #i and task #j asynchronously (Step S404).

By contrast, if the calculation speed does not increase (No at Step S403), the asynchronous execution determiner 140 determines to execute task #i and task #j sequentially (Step S405).

Subsequently, the asynchronous execution determiner 140 determines whether j=K−1 is satisfied (Step S406). If j≠K−1 is satisfied (No at Step S406), the asynchronous execution determiner 140 increments j by one (Step S407). Subsequently, the asynchronous execution determiner 140 performs Step S403 again.

By contrast, if j=K−1 is satisfied (Yes at Step S406), the asynchronous execution determiner 140 determines whether i=M−1 is satisfied (Step S408). If i≠M−1 is satisfied (No at Step S408), the asynchronous execution determiner 140 increments i by one (Step S409). Subsequently, the asynchronous execution determiner 140 performs Step S403 again.

By contrast, if i=M−1 is satisfied (Yes at Step S408), the asynchronous execution determiner 140 terminates the asynchronous execution determination process.

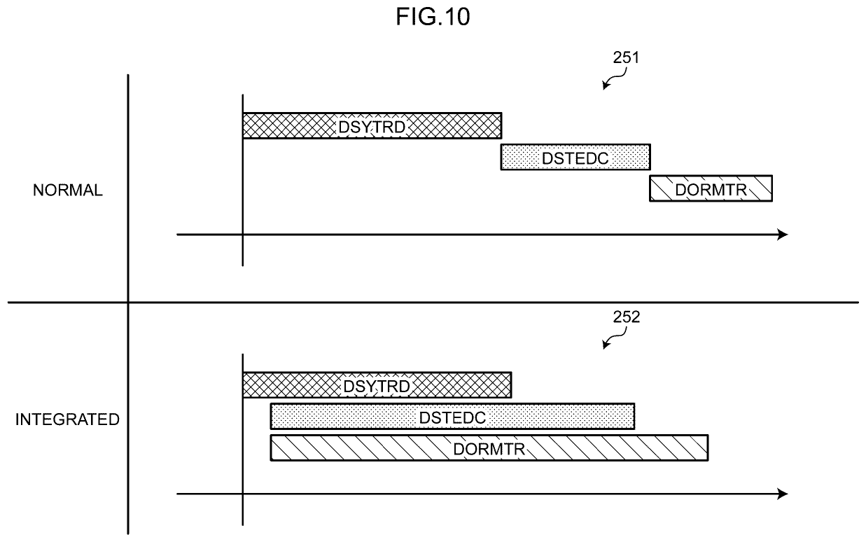

FIG. 10 is a diagram of an example of a timeline comparing a case where asynchronous execution of the units of calculation is performed and a case where not performed in the calculation of the standard eigenvalue problem. Normally, the processor 10 executes DSTEDC after DSYTRD is completed and performs DORMIR after DSTEDC is completed as indicated by a graph 251. By contrast, if the units of calculation are asynchronously executed, the processor 10 can process DSTEDC and DORMIR in parallel with DSYTRD when a predetermined task in DSYTRD is completed as indicated by a graph 252, for example. The comparison between the graph 251 and the graph 252 indicates that the processing in the graph 252 ends earlier than the processing in the graph 251. In FIG. 10, the tasks are continuously executed in the asynchronous execution of the tasks. If the tasks have the dependencies illustrated in FIG. 5, for example, a wait for synchronization may occur until a specific task is completed in DSYTRD, DSTEDC, and DORMTR.

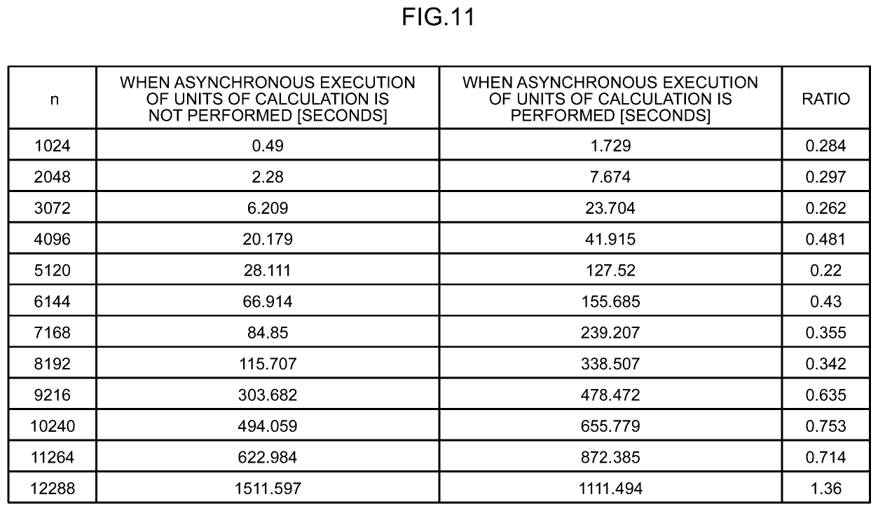

FIG. 11 is a diagram of a comparison of the calculation speed between the calculation of the standard eigenvalue problem by the processor according to the first embodiment and the calculation when asynchronous execution of the units of calculation is not performed. In FIG. 11, the symmetric matrix is an n×n matrix where n is 1024, 2048, 3072, 4096, 5120, 6144, 7168, 8192, 9216, 10240, 11264, and 12288.

In this case, when the order of the symmetric matrix increases to 12288×12288, the asynchronous execution of the units of calculation becomes effective, and the processor 10 can increase the speed of calculation of the standard eigenvalue problem by approximately 30% compared with the calculation method not performing the asynchronous execution of the units of calculation.

As described above, the processor serving as the arithmetic processing device according to the present embodiment divides the calculation of the standard eigenvalue problem for a symmetric matrix into units of calculation according to the predetermined rules. The processor defines the units of calculation as tasks and determines whether to execute the tasks asynchronously based on their dependencies and calculates the standard eigenvalue problem for the symmetric matrix according to the determination. With this configuration, the processor can individually calculate the tasks in parallel during a wait time when the parallelism of the used cores is low, thereby hiding a wait time due to cache miss. Therefore, if there is a tendency to be less likely to cause cache hits, the calculation efficiency can be improved, and the calculation speed can be increased by the divide-and-conquer method, thereby improving the calculation efficiency for the standard eigenvalue problem.

### (b) Second Embodiment

Next, a second embodiment is described. The processor according to the second embodiment performs asynchronous calculation by dividing DSTEDC, which is a function to solve the standard eigenvalue problem of a tridiagonal matrix in the calculation of the standard eigenvalue problem by the divide-and-conquer method, into a plurality of different types of units of calculation. The computer 1 according to the present embodiment is also illustrated in the block diagram in FIG. 1. In the following description, explanation of the operations of each unit similar to those according to the first embodiment is omitted.

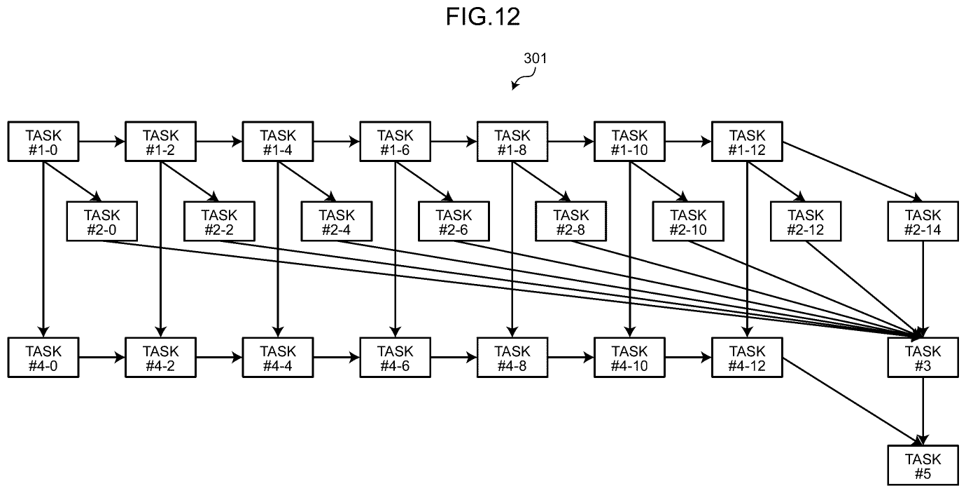

FIG. 12 is a diagram of an example of the dependency graph according to the second embodiment. FIG. 12 illustrates an example of the dependency between tasks corresponding to the units of calculation in the calculation of the standard eigenvalue problem.

The calculation unit divider 101 divides the calculation in DSYTRD, DSTEDC, and DORMIR into the units of calculation as follows. The dependencies of the units of calculation according to the present embodiment are finally indicated by a dependency graph 301 illustrated in FIG. 12. The processor 10 according to the present embodiment divides a 16×16 tridiagonal matrix into 2×2 matrices in the calculation by DSYTRD. Actually, however, the processor 10 need not divide the matrix into as small as 2×2 matrices, and the division size of the matrix preferably varies with the used architecture.

For example, the calculation unit divider 101 defines calculation of two-column tridiagonalization by DSYTRD in the calculation of the standard eigenvalue problem as one unit of calculation. Task #1-i in FIG. 12 represents the unit of calculation for performing the two-column tridiagonalization of performing tridiagonalization on the two columns from the i-th column. Task #1-i also includes similarity transformation. The matrix is divided in 2×2 units in DSTEDC, so the calculation unit divider 101 defines the tridiagonalization of each two columns in DSYTRD as the unit of calculation.

The calculation unit divider 101 also defines each division at each stage until the tridiagonal matrix is divided into 2×2 matrices by DSTEDC and the calculation of eigenvalues and eigenvectors in the calculation of the standard eigenvalue problem as one unit of calculation. Task #2-i in FIG. 12 represents the unit of calculation for dividing the two columns from the i-th column into 2×2 matrices and calculating the eigenvalues and eigenvectors of the 2×2 matrices resulting from division.

The calculation unit divider 101 collectively defines the entire calculation of recursive integration of eigenvalues and eigenvectors repeated from the terminal 2×2 matrix by DSTEDC in the calculation of the standard eigenvalue problem as one unit of calculation. Task #3 in FIG. 12 represents the unit of calculation for calculating the eigenvalues and eigenvectors of the tridiagonal matrix using the eigenvalues and eigenvectors of eight 2×2 matrices resulting from division.

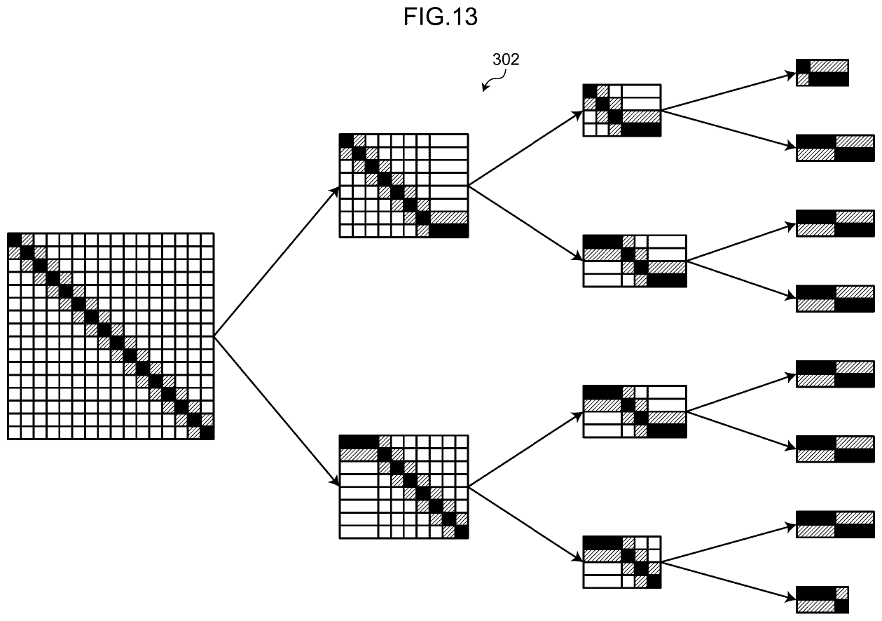

FIG. 13 is a diagram of division of the matrix in DSTEDC. The processor 10 according to the present embodiment repeatedly divides the tridiagonal matrix into halves in DSTEDC as illustrated in a division state 302 in FIG. 13 and calculates eigenvalues and eigenvectors of the matrices that are sufficiently small. The processor 10 can use a method with lower processing load, such as the QR method, other than the divide-and-conquer method to calculate the eigenvalues and eigenvectors of the sufficiently small matrices. The calculations of the eigenvalues and eigenvectors of the sufficiently small matrices have no dependencies with each other, so the processor 10 can calculate the eigenvalues and eigenvectors of the matrices in parallel.

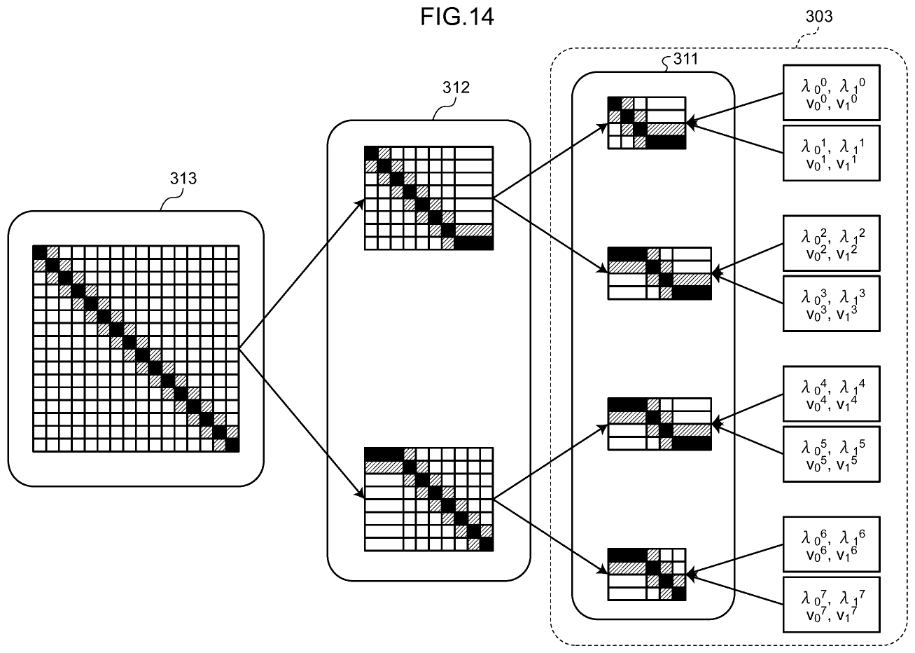

FIG. 14 is a diagram of the calculation of the eigenvalues and eigenvectors of the recursive matrices in DSTEDC. When the calculations of the eigenvalues and eigenvectors of the sufficiently small matrices are completed, the processor 10 calculates the eigenvalues and eigenvectors of the original matrix as indicated by processing 303 in FIG. 14. The processor 10 uses the eigenvalues and eigenvectors of two matrices resulting from division to calculate the eigenvalues and eigenvectors of the original matrix. The processor 10 can calculate the eigenvalues and eigenvectors of the tridiagonal matrix before division by repeating this calculation at stages 311 to 313. The calculation of the eigenvalues and eigenvectors of the original matrix has no dependencies with the calculation of those of another original matrix, so the processor 10 can calculate the eigenvalues and eigenvectors of the original matrices in parallel. Furthermore, the eigenvalues and eigenvectors of the original matrix can be calculated using matrix multiplication, and the processor 10 can improve the calculation efficiency by using this calculation method.

The calculation unit divider 101 collectively defines the entire calculation of the recursive integration of the eigenvalues and eigenvectors at the stages 311 to 313 in FIG. 14 as one unit of calculation. It is known that the calculation performance of the processor 10 is improved by performing batch processing on the integration of the eigenvalues and eigenvectors at the stages 311 to 313. Therefore, the calculation unit divider 101 collectively defines the calculations of recursive integration of the eigenvalues and eigenvectors at the stages 311 to 313 as one unit of calculation.

The calculation unit divider 101 defines transformation of the Householder matrix Hi held in a vector form into a matrix form by the DORMTR in the calculation of the standard eigenvalue problem as one unit of calculation. Task #4-i in FIG. 12 represents the unit of calculation for transforming the Householder matrix Hi of the i-th column into a matrix form.

The calculation unit divider 101 defines matrix multiplication by DORMTR in the calculation of the standard eigenvalue problem as one unit of calculation. Task #5 in FIG. 12 represents this unit of calculation.

The dependency determiner 103 receives input of the dependency graph 301 in FIG. 12, for example, from the dependency graph generator 102.

In the dependency graph 301, there is no path connecting from task #2-0 to task #4-0 or from task #4-0 to task #2-0 between task #2-0 and task #4-0. Therefore, the dependency determiner 103 determines that no dependency is present between task #2-0 and task #4-0. Similarly, there is no path connecting between task #2-2 and task #4-2 in either direction, so the dependency determiner 103 determines that no dependency is present between task #2-2 and task #4-2.

By contrast, there is no path connecting from task #4-8 to task #1-4 between task #1-4 and task #4-8, but there is a path connecting from task #1-4 to task #4-8. Therefore, the dependency determiner 103 determines that a dependency is present between task #1-4 and task #4-8.

The asynchronous execution determiner 140 uses the dependencies received from the dependency determiner 103 to determine whether to perform asynchronous calculation. In FIG. 12, for example, no dependency is present between task #2-i and task #4-i after task #1-i is completed. Therefore, the asynchronous execution determiner 140 determines that task #2-i and task #4-i can be asynchronously calculated. If performing asynchronous calculation improves the calculation efficiency, the asynchronous execution determiner 140 determines to execute task #2-i and task #4-i asynchronously.

The calculation executer 104 calculates the standard eigenvalue problem for a plurality of units of calculation including the units of calculation obtained by dividing DSTEDC by the calculation unit divider 101 according to whether dependencies are present between the tasks. In other words, the calculation executer 104 executes the calculation for a plurality of units of calculation including the units of calculation obtained by dividing the calculation of eigenvalues and eigenvectors for the tridiagonal matrix obtained from tridiagonalization of the symmetric matrix based on whether a dependency is present between the first task and the second task.

The calculation executer 104 calculates the units of calculation that can be asynchronously executed using the task parallel function of OpenMP. The calculation executor 104 may process task #2-i in one thread because the processing load of task #2-i is relatively light. By contrast, the calculation executer 104 preferably processes task #4-i in a plurality of threads because the processing load of task #4-i is relatively heavy. Therefore, the calculation executer 104 executes the processing of task #2-i using #pragma omp task and the processing of task #4-i using #pragma omp taskloop. With this configuration, after the calculation of the thread allocated to task #2-i is completed, the calculation executor 104 may be able to allocate the thread to the processing of task #4-1. Therefore, the calculation efficiency of the processor 10 can be improved.

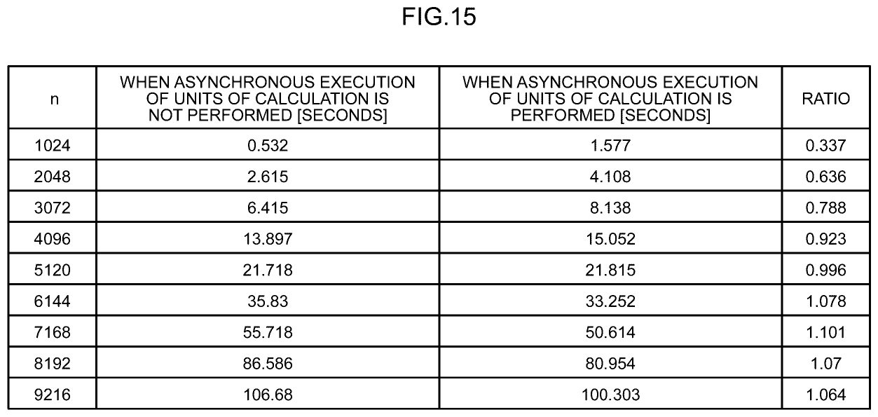

FIG. 15 is a diagram of a comparison of the calculation speed between the calculation of the standard eigenvalue problem by the processor according to the second embodiment and the calculation when asynchronous execution of the units of calculation is not performed. In FIG. 15, the symmetric matrix is an n×n matrix where n is 1024, 2048, 3072, 4096, 5120, 6144, 7168, 8192, and 9216.

In this case, when the matrix size is sufficiently large, and the parallelism is sufficiently large, a large number of cores can be fully used. Thus, it is found out that the calculation by the processor 10 according to the present embodiment is effective. For another example not illustrated in FIG. 15, in the calculation of eigenvalues and eigenvectors of a 10240×10240 symmetric matrix, the processor 10 can increase the speed of calculation of the standard eigenvalue problem by approximately 20% compared with the calculation method not executing the units of calculation asynchronously.

As described above, the processor serving as the arithmetic processing device according to the present embodiment defines the division of the tridiagonal matrix into 2×2 matrices by DSTEDC and the calculation of eigenvalues and eigenvectors in the calculation of the standard eigenvalue problem as one unit of calculation. The processor collectively defines the entire calculation of the recursive integration of eigenvalues and eigenvectors repeated from the terminal 2×2 matrix by DSTEDC in the calculation of the standard eigenvalue problem as one unit of calculation. The processor defines the units of calculation as tasks to determine whether to execute the tasks asynchronously based on their dependencies and calculates the standard eigenvalue problem for the symmetric matrix according to the determination. With this configuration, when the matrix size is sufficiently large, and the parallelism is sufficiently large in DSTEDC, a large number of cores can be fully used. Therefore, the calculation efficiency for the standard eigenvalue problem can be improved.

### (c) Third Embodiment

Next, a third embodiment is described. The processor according to the third embodiment is different from that according to the first and the second embodiments in the units of calculation generated by dividing DSTEDC and DORMIR in the calculation of the standard eigenvalue problem. The computer 1 according to the present embodiment is also illustrated in the block diagram in FIG. 1. In the following description, explanation of the operations of each unit similar to those according to the first embodiment is omitted.

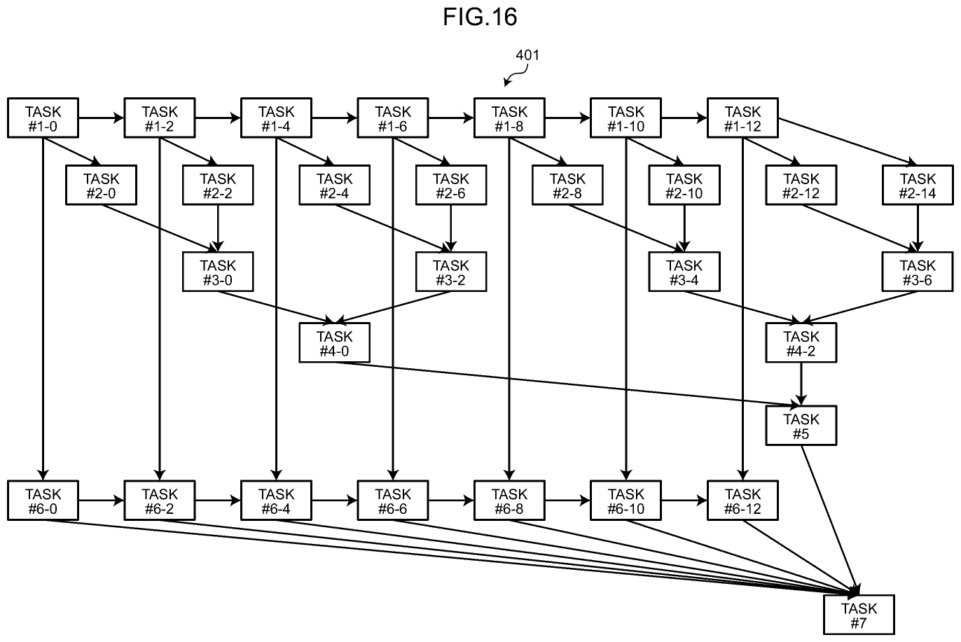

FIG. 16 is a diagram of an example of the dependency graph according to the third embodiment. FIG. 16 illustrates an example of the dependencies between tasks corresponding to the units of calculation in the calculation of the standard eigenvalue problem.

The calculation unit divider 101 divides the calculation in DSYTRD, DSTEDC, and DORMTR into the units of calculation as follows. The dependencies of the units of calculation according to the present embodiment are finally indicated by a dependency graph 401 illustrated in FIG. 16. The processor 10 according to the present embodiment divides a 16×16 tridiagonal matrix into 2×2 matrices in the calculation by DSYTRD. Actually, however, the processor 10 need not divide the matrix into as small as 2×2 matrices, and the division size of the matrix preferably varies with the used architecture.

For example, the calculation unit divider 101 defines calculation of two-column tridiagonalization by DSYTRD in the calculation of the standard eigenvalue problem as one unit of calculation. Task #1-i in FIG. 16 represents the unit of calculation for performing the two-column tridiagonalization of performing tridiagonalization on the two columns from the i-th column. Task #1-i also includes similarity transformation. The matrix is divided in 2×2 units in DSTEDC, so the calculation unit divider 101 defines the tridiagonalization of each two columns in DSYTRD as the unit of calculation.

The calculation unit divider 101 also defines each division at each stage until the tridiagonal matrix is divided into 2×2 matrices by DSTEDC and the calculation of eigenvalues and eigenvectors in the calculation of the standard eigenvalue problem as one unit of calculation. Task #2-i in FIG. 16 represents the unit of calculation for dividing the two columns from the i-th column into 2×2 matrices and calculating the eigenvalues and eigenvectors of the 2×2 matrices resulting from division. While the values are determined from the upper left element in tridiagonalization, the 2×2 matrix resulting from division can be derived using only the determined elements.

The calculation unit divider 101 defines the calculation of integration of the eigenvalues and eigenvectors of 2×2 matrices by DSTEDC in the calculation of the standard eigenvalue problem as one unit of calculation. Task #3-i in FIG. 16 is the unit of calculation for integrating the eigenvalues and eigenvectors of the i-th and the i+1-th matrices when the 2×2 matrices are arranged and sequentially numbered from the top corresponding to the original tridiagonal matrix.

The calculation unit divider 101 defines the calculation of integration of the eigenvalues and eigenvectors of 4×4 matrices by DSTEDC in the calculation of the standard eigenvalue problem as one unit of calculation. Task #4-i in FIG. 16 is the unit of calculation for integrating the eigenvalues and eigenvectors of the i-th and the i+1-th matrices when the 4×4 matrices are arranged and sequentially numbered from the top corresponding to the original tridiagonal matrix.

The calculation unit divider 101 defines the calculation of integration of the eigenvalues and eigenvectors of 8×8 matrices by DSTEDC in the calculation of the standard eigenvalue problem as one unit of calculation. Task #5-i in FIG. 16 is the unit of calculation for integrating the eigenvalues and eigenvectors of the i-th and the i+1-th matrices when the 8×8 matrices are arranged and sequentially numbered from the top corresponding to the original tridiagonal matrix.

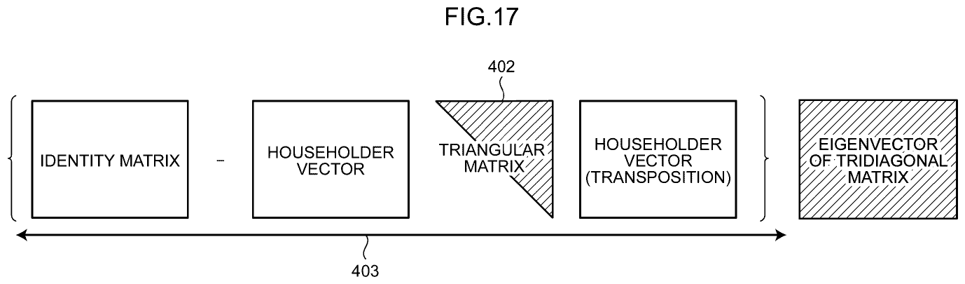

The calculation unit divider 101 defines the calculation of a triangular matrix portion in transformation used in task #1-i by DORMIR in the calculation of the standard eigenvalue problem as one unit of calculation. FIG. 17 is a diagram of the outline of calculation by DORMIR according to the third embodiment. The Householder matrix used for the tridiagonalization has a form called compact WY representation, and a plurality of Householder matrices may be collectively applied. The processor 10 according to the present embodiment collectively applies two Householder transformations in the tridiagonalization as indicated by a calculation 403 in FIG. 17. In FIG. 17, the eigenvectors of the tridiagonal matrix are obtained by seven calculations 403. In this calculation 403, a triangular matrix 402 is used to collectively apply the two Householder transformations. Therefore, to perform inverse transformation of the eigenvectors, the processor 10 calculates the 2×2 triangular matrix 402. Task #6-i in FIG. 16 is the unit of calculation for performing this calculation, that is, the unit of calculation for calculating the triangular matrix portion in transformation used in task #1-i.

The calculation unit divider 101 defines the calculation of inverse transformation of the eigenvectors of the tridiagonal matrix by DORMIR in the calculation of the standard eigenvalue problem as one unit of calculation. Task #7 in FIG. 17 represents this unit of calculation.

The asynchronous execution determiner 140, for example, uses the dependencies illustrated in FIG. 17 received from the dependency determiner 103 to determine whether to calculate the tasks asynchronously and determines the tasks to be asynchronously processed. The calculation executer 104 executes the calculation of the standard eigenvalue problem according to the determination of the asynchronous execution determiner 140.

Thus, the calculation executer 104 calculates the standard eigenvalue problem for a plurality of units of calculation including the units of calculation obtained by dividing DSTEDC and DORMIR by the calculation unit divider 101 according to whether dependencies are present between the tasks. In other words, the calculation executer 104 executes the calculation for the units of calculation having the number including the unit of calculation for calculating the triangular matrix used in the inverse transformation of the eigenvectors of the tridiagonal matrix based on whether a dependency is present between the first task and the second task.

The processor according to the present embodiment can control the tasks highly flexibly. The processor can increase the number of tasks asynchronously executed and enhance the thread parallelism of the tasks in an environment where the operations of BLAS and LAPACK can be performed with high performance. With this configuration, the processor can improve the calculation performance for the standard eigenvalue problem.

In one aspect, the present invention can improve the calculation efficiency for the standard eigenvalue problem.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device comprising:
processing circuitry configured to:
asynchronously calculate, for a plurality of units of calculation for performing respective different calculations generated by dividing calculation of a standard eigenvalue problem for a predetermined symmetric matrix, a first task and a second task out of a plurality of tasks in which the respective units of calculation are executed when a dependency in which calculation of one of the first task and the second task is performed based on a result of calculation of the other is not present between the first task and the second task and sequentially calculate the first task and the second task when the dependency is present between the first task and the second task; and
output a result of the calculation of the standard eigenvalue problem for the predetermined symmetric matrix calculated by the calculating.

2. The arithmetic processing device according to claim 1, wherein the processing circuitry is configured to execute the calculation of the unit of calculation in a plurality of threads for each of the first task and the second task when the amount of calculation of the unit of calculation to be executed is equal to or larger than a predetermined value.

3. The arithmetic processing device according to claim 1, wherein the processing circuitry is configured to:
generate a dependency graph indicating an input-output relation of a result of the calculation between the tasks,
determine whether the dependency is present between the first task and the second task based on the dependency graph generated.

4. The arithmetic processing device according to claim 1, wherein the processing circuitry is further configured to execute the calculation for the units of calculation including units of calculation obtained by dividing calculation of tridiagonalization of a symmetric matrix included in the calculation of the standard eigenvalue problem for the predetermined symmetric matrix based on whether the dependency is present between the first task and the second task.

5. The arithmetic processing device according to claim 1, wherein the processing circuitry is further configured to execute the calculation for the units of calculation including units of calculation obtained by dividing calculation of an eigenvalue and an eigenvector for a tridiagonal matrix obtained from tridiagonalization of a symmetric matrix included in the calculation of the standard eigenvalue problem for the predetermined symmetric matrix based on whether the dependency is present between the first task and the second task.

6. The arithmetic processing device according to claim 5, wherein the processing circuitry is further configured to execute the calculation for the units of calculation including a unit of calculation for calculating a triangular matrix used in inverse transformation of the eigenvector of the tridiagonal matrix based on whether the dependency is present between the first task and the second task.

7. An arithmetic processing method comprising:
asynchronously calculating, for a plurality of units of calculation for performing respective different calculations generated by dividing calculation of a standard eigenvalue problem for a predetermined symmetric matrix, a first task and a second task out of a plurality of tasks in which the respective units of calculation are executed when a dependency in which calculation of one of the first task and the second task is performed based on a result of calculation of the other is not present between the first task and the second task; and
sequentially calculating the first task and the second task when the dependency is present between the first task and the second task, by processing circuitry.

8. The arithmetic processing method according to claim 7, further including executing the calculation of the unit of calculation in a plurality of threads for each of the first task and the second task when the amount of calculation of the unit of calculation to be executed is equal to or larger than a predetermined value.

9. The arithmetic processing method according to claim 7, further including:
generating a dependency graph indicating an input-output relation of a result of the calculation between the tasks; and
determining whether the dependency is present between the first task and the second task based on the generated dependency graph.

10. The arithmetic processing method according to claim 7, wherein the calculating the first task and the second task includes executing the calculation for the units of calculation including units of calculation obtained by dividing calculation of tridiagonalization of a symmetric matrix included in the calculation of the standard eigenvalue problem for the predetermined symmetric matrix based on whether the dependency is present between the first task and the second task.

11. The arithmetic processing method according to claim 7, wherein the calculating the first task and the second task includes executing the calculation for the units of calculation including units of calculation obtained by dividing calculation of an eigenvalue and an eigenvector for a tridiagonal matrix obtained from tridiagonalization of a symmetric matrix included in the calculation of the standard eigenvalue problem for the predetermined symmetric matrix based on whether the dependency is present between the first task and the second task.

12. The arithmetic processing method according to claim 11, wherein the calculating the first task and the second task includes executing the calculation for the units of calculation including a unit of calculation for calculating a triangular matrix used in inverse transformation of the eigenvector of the tridiagonal matrix based on whether the dependency is present between the first task and the second task.
